(19) United States
(12) Patent Application Publication
(10) Pub. No.: US 2025/0019867 A1
(43) Pub. Date: Jan. 16, 2025

(54) COMPOSITIONS FOR PRODUCING CELLULOSE-RESILIN AND CELLULOSE-COLLAGEN FIBERS

(71) Applicant: BOLT THREADS, INC., Emeryville, CA (US)

(72) Inventor: David Breslauer, Emeryville, CA (US)

(21) Appl. No.: 18/713,165

(22) PCT Filed: Nov. 22, 2022
(86) PCT No.: PCT/US22/50724

§ 371 Date: May 23, 2024

Related U.S. Application Data
(60) Provisional application No. 63/282,938, filed on Nov. 24, 2021.

(51) Int. Cl. D01F 8/02; C08L 1/02; D01F 2/00

(52) U.S. Cl. CPC D01F 8/02; C08L 1/02; D01F 2/00

(57) ABSTRACT

The present disclosure relates to novel compositions for use in producing textile fibers by spinning from an aqueous suspension of micro fibrillated cellulose directly into fibers. The compositions comprise, in addition to microfibrillated cellulose, one or more elastomeric proteins that function to improve the clastic properties of the fibers produced. Example elastomeric proteins that modulate the properties of the textile fibers are resilin and collagen.

### FIELD OF THE INVENTION

The present invention relates generally to the field of compositions for producing textile fibers, specifically for spinning microfibrillated cellulose directly into fibers, more specifically modifying the properties of the fibers by including elastomeric proteins, which in some embodiments of the invention are cross-linked.

### BACKGROUND

The present disclosure relates to novel compositions for producing textile fibers by spinning from an aqueous suspension of microfibrillated cellulose directly into fibers. Most conventional methods for producing textile fibers involve dissolving cellulose in a solvent and then coagulating it into a fiber.

A fundamental challenge relating to the direct spinning into fibers, specifically for the spinning of microfibrillated cellulose, is that the process often results in coarse and stiff fibers, so this process is only suitable for a small number of textile process and applications. Ideally, the fibers would have greater extensibility and be smoother.

Methods for producing fiber yarns and other products from cellulosic materials are known. The methods, however, usually include chemical treatment of cellulose before or during manufacture of the product. For Example: JP 4004501 B; JP 10018123; JP 2004339650; JP 4839973; EP 1493859; CN 102912622; CN 101724931; WO 2009028919; and DE 19544097.

Industrial Biotechnology (2015) 11:44 discloses bionanocomposite films from resilin-CBD bound to cellulose nanocrystals. This research discloses the properties of bionanocomposite films prepared by binding recombinant resilin-like protein (res) consisting of the exon 1 resilin sequence from Drosophila melanogaster engineered to include a cellulose binding domain (CBD), to cellulose nanocrystals (CNCs). The optimal binding of res-CBD to CNCs was 1:5 by mass, and the resulting res-CBD-CNCs remained colloidally stable in water. Res-CBD-CNCs were solvent cast into transparent, free-standing films, which were more hydrophobic than neat CNC films, with water contact angles of 70-80° compared to 35-40° for the latter. In contrast to the multi-domain orientation typical of chiral nematic CNC films, res-CBD-CNC and CBD-CNC films exhibited long-range, uniaxial orientation that was apparently driven by the CBD moiety. Glycerol was studied as an additive in the films to determine whether the addition of a wet component to solvate the recombinant protein improved the mechanical properties of the res-CBD-CNC films. In comparison to the other films, res-CBD-CNC films were more elastic with added glycerol, demonstrating a range of 0.5-5 wt % (i.e., the films responded more elastically to a given strain and/or were less plastically deformed by a given mechanical load), but became less elastic with added glycerol between 0.5-5 wt %. Overall, films made of res-CBD-CNCs plus 0.5 wt % glycerol displayed improved mechanical properties compared to neat CNC films, and with an increase in toughness of 150% and in elasticity of 100%.

Biomacromolecules (2017) 18:1866 discloses elastic and pH-responsive hybrid interfaces created with engineered resilin and nanocellulose. The disclosure investigated how a genetically engineered resilin fusion protein modifies cellulose surfaces. The document characterized the pH-responsive behavior of a resilin-like polypeptide (RLP) having terminal cellulose binding modules (CBM) and showed its binding to cellulose nanofibrils (CNF). Characterization of the resilin fusion protein at different pHs revealed substantial conformational changes of the protein, which were observed as swelling and contraction of the protein layer bound to the nanocellulose surface. In addition, it was shown that employment of the modified resilin in cellulose hydrogel and nanopaper increased their modulus of stiffness through a cross-linking effect.

ACS Nano. (2017) 11:5148 discloses functional materials comprising combinations of simple components to achieve desired properties. Silk and cellulose are two examples from nature—spider silk being tough due to high extensibility, whereas cellulose possesses unparalleled strength and stiffness among natural materials. Unfortunately, silk proteins cannot be obtained in large quantities from spiders, and recombinant production processes are so far rather expensive. The disclosure combined small amounts of functionalized recombinant spider silk proteins with cellulose nanofibrils (CNFs) to fabricate isotropic as well as anisotropic hierarchical structures. The approach for the fabrication of bio-based anisotropic fibers results in previously unreached but highly desirable mechanical performance with a stiffness of □55 GPa, strength at break of □1015 MPa, and toughness of □55 MJ m-3. The disclosure shows that addition of small amounts of silk fusion proteins to CNF results in materials with advanced biofunctionalities, which cannot be anticipated for the wood-based CNF alone. These findings suggest that bio-based materials provide abundant opportunities to design composites with high strength and functionalities and bring down our dependence on fossil-based resources

Angewandte Chemie. (2015) 5:12193 discloses modular architecture of protein binding units for designing properties of cellulose nanomaterials. Molecular biomimetic models suggest that proteins in the soft matrix of nanocomposites have a multimodular architecture. Engineered proteins were used together with nanofibrillated cellulose (NFC) to show how this type of architecture leads to function. The proteins consist of two cellulose-binding modules (CBM) separated by 12-, 24-, or 48-mer linkers. Engineering the linkers has considerable effects on the interaction between protein and NFC in both wet colloidal state and a dry film. The protein optionally incorporates a multimerizing hydrophobin (HFB) domain connected by another linker. The modular structure explains effects in the hydrated gel state, as well as the deformation of composite materials through stress distribution and crosslinking. Based on this work, strategies can be suggested for tuning the mechanical properties of materials through the coupling of protein modules and their interlinking architectures.

Science Advances (2019) 5:9 disclose biomimetic composites with enhanced toughening using silk-inspired triblock proteins and aligned nanocellulose reinforcements. Silk and cellulose are biopolymers that show strong potential as future sustainable materials. They also have complementary properties, suitable for combination in composite materials where cellulose would form the reinforcing component and silk the tough matrix. A major challenge concerns balancing structure and functional properties in the assembly process. Recombinant proteins with triblock architecture were used, combining structurally modified spider silk with terminal cellulose affinity modules. Flow alignment of cellulose nanofibrils and triblock protein allowed continuous fiber production. Protein assembly involved phase separation into concentrated coacervates, with subsequent conformational switching from disordered structures into β sheets. This process gave the matrix a tough adhesiveness, forming a new composite material with high strength and stiffness combined with increased toughness. The process showed that versatile design possibilities in protein engineering enabled new fully biological materials and emphasize the key role of controlled assembly at multiple length scales for realization.

US20200362474 (Spinnova) discloses embodiments describe a reconstructed filament comprising natural protein fibrils and an additive. Disclosed embodiments also describe a wool comprising: a plurality of staple fibers formed of reconstructed filaments, wherein the reconstructed filaments comprise natural protein fibrils and an additive. Disclosed embodiments also describe a yarn spun from staple fibers, the yarn comprising: staple fibers comprising reconstructed filament, wherein the reconstructed filament comprises natural protein fibrils and an additive. Disclosed embodiments also describe an item comprising a reconstructed filament, wherein the reconstructed filament comprises natural protein fibrils and an additive.

US20200048794 (Spinnova) discloses embodiments describe a method for manufacturing a staple fiber based on natural protein fiber. The method may include: providing a protein suspension, the protein suspension comprising fibrils of the natural protein fiber; directing the protein suspension through a nozzle onto a surface for forming a protein-based fiber; drying the protein suspension on the surface; extracting the fiber from the surface; and providing the staple fiber. Disclosed embodiments may further describe a fiber based raw wool. The raw wool may include staple fibers, wherein the staple fibers are reconstructed on the basis of protein fibrils and are mechanically subdivided from natural protein fibers, wherein the protein fibrils are interlocked by hydrogen bonds, and wherein the raw wool comprises an unoriented, entangled, fluffy network of staple fibers.

All documents cited herein are incorporated by reference.

None of the above cited documents, alone or in combination satisfy the need for an aqueous suspension of microfibrillated cellulose that can be directly spun from the aqueous suspension into fibers having improved viscoelastic mechanical properties.

### BRIEF SUMMARY

It is an object of the invention to provide compositions and processes for producing cellulose-resilin and cellulose-collagen fibers.

In accordance with an aspect of the invention there is provided a composition for use in the production of cellulose fibers, the composition comprising: a cellulosic pulp suspension; and one or more cross-linked elastomeric proteins selected from the group comprising: resilin; collagen; abductin; and octopus arterial elastomers.

In one embodiment of the invention, the elastomeric protein will be crosslinked after fiber formation. In another embodiment, it will be lightly crosslinked in suspension and then fully crosslinked after fiber formation.

In accordance with another aspect of the invention there is provided a composition as described above, wherein the elastomeric protein is resilin.

In accordance with another aspect of the invention there is provided a composition as described above, wherein the resilin is crosslinked.

In accordance with another aspect of the invention there is provided a composition as described above, wherein the elastomeric protein is collagen.

The advantages and features of the present invention will become better understood with reference to the following more detailed description and claims taken in conjunction with the accompanying drawings in which like elements are identified with like symbols.

### DETAILED DESCRIPTION

Compositions and methods for carrying out the invention are presented in terms of embodiments described herein. However, the invention is not limited to the described embodiments, and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and the configurations shall be shown and described for purposes of clarity and disclosure and not by way of limitation of scope.

In order to overcome the previously described shortcomings associated with direct spinning of cellulosic fibers, specifically microfibrillated cellulose, from an aqueous suspension, it has been found that incorporating elastomeric proteins into the aqueous suspension results in fibers having improved viscoelastic mechanical properties.

Cellulose is typically solubilized and coagulated in a multi-stage process. Some embodiments of the invention involve wood being broken down into nano fibrils which are extruded from water, with subsequent drying, into fibers. Other embodiments of the invention involve the cellulosic material being dissolved in an NMMO solvent and extruding the solution into a water bath causing the fibers to coagulate.

In accordance with embodiments of the invention, one or more elastomeric proteins are added to a cellulosic material for form a fiber forming composition. In some embodiments, the cellulosic material is dissolved before admixing with the elastomeric proteins. In some embodiments of the invention, one or more cross-linkers are also added. The elastomeric proteins can be cross-linked before or after fiber formation. For example, the elastomeric proteins can be cross-linked before being admixed with the cellulosic material. For example, the elastomeric proteins can be cross-linked after being admixed with the cellulosic material, but before the fiber is formed. A still further option is cross-linking the elastomeric protein after fiber formation. The cellulosic material and the one or more elastomeric proteins can be admixed prior to coagulation. The solubilized cellulose material, elastomeric proteins and optional cross-linkers are then coagulated in a water bath to produce fibers and heat or UV is used to crosslink the elastomeric proteins. Alternatively, the admixture of the cellulosic material, the one or more elastomeric proteins and optional cross-linkers can be directly spun into fibers as opposed to through a coagulation method.

The fiber forming composition of the disclosure can include about 1% to 50% elastomeric protein based on the total solids content of the composition. Other suitable amounts include about 2% to about 40%, about 5% to about 20%, about 10% to about 30% or about 1% to about 15%, based on the total solids content of the fiber forming composition. For example, the elastomeric protein can be about 1, 2, 3, 4, 5, 6, 7, 8, 9, 10, 11, 12, 13, 14, 15, 16, 17, 18, 19, 20, 22, 24, 26, 28, 30, 32, 34, 36, 38, 40, 42, 44, 46, 48, 50% based on the total solids content of the fiber forming composition, and any values there between and any ranges defined such values.

Elastomeric proteins include structural proteins, such as collagen, elastin, keratin, silk and resilin. The proteins may also be referred to as native proteins if they have not undergone any chemical modification. The various elastomeric proteins exhibit long-range ordered molecular secondary structures that arise due to the highly repetitive primary amino acid sequences within the proteins. Secondary structures include twisted helices (keratins), beta-pleated sheets (spider silk), coiled coils (bee silk), beta-spirals (elastin), beta-turns (resilin) and triple helices (collagen). Other proteins may include abductin, gelatin and octopus arterial elastomers. The proteins may also be physically or chemically treated, such as gelatin. For example, if collagen is partly irreversibly hydrolyzed (e.g., by heat and/or chemicals), it is termed gelatin, hence gelatin is regarded as a modified protein. The elastomeric proteins may additionally be crosslinked using methods known in the field.

Resilin is a particularly interesting elastomeric protein because it dissipates very little energy during loading and unloading. Resilin is found in many insects, and the low energy dissipation enables the extraordinary ability of many insect species to jump or pivot their wings very efficiently. The unique properties of resilin make it an interesting elastomeric material that could have many industrial applications, specifically in the textile industry.

Resilins have many unique properties compared to petroleum-based elastomers. Most notably, resilin has an extreme elastic efficiency, where very little of the energy input into deformation is lost as heat. Other desirable properties of resilin include, for example, desirable resilience, compressive elastic modulus, tensile elastic modulus, shear modulus, extension to break, maximum tensile strength, hardness, rebound, and compression set. Moreover, resilin is a protein, and therefore can be biodegraded, which makes it more environmentally friendly than petroleum-based polymers. Also, resilin is biocompatible and can therefore be used in applications that involve contact with humans or animals. Lastly, the mechanical properties of recombinant resilins can be tuned through varying protein sequence, protein structure, amount of intermolecular cross-linking and processing variables to produce elastomers designed for a universe of specific applications.

Natural resilins and resilin-like proteins (based on resilin sequences) have been recombinantly produced by a number of groups in E. coli cultures, and have been isolated by lysing the cells to extract recombinantly expressed proteins, and using affinity chromatography techniques to purify (Elvin et al., 2005; Charati et al.; 2009, McGann et al., 2013). The recombinantly produced resilin and resilin-like proteins have been cross-linked targeting the tyrosine residues that also form the cross-links in natural resilin (see, for example, Elvin et al., 2005; Qin et al., 2011). Recombinantly produced resilin has also been cross-linked targeting lysine residues (Li et al., 2011) or cysteine residues (McGann et al., 2013). Cross-linked recombinantly produced resilin and resilin-like proteins have shown mechanical properties similar to those of natural resilin, with resilience values in excess of 90% (Elvin et al., 2005, Qin et al., 2011, Li et al., 2011).

Alternative embodiments include producing a composition comprising recombinant resilin, the method comprising the step of culturing a recombinant host cell comprising one or more vectors comprising a secreted resilin coding sequence to produce a fermentation under conditions that promote secretion of recombinant resilin from the recombinant host cell. The method comprises culturing a population of recombinant host cells in a fermentation, wherein the recombinant host cells comprise a vector comprising a secreted resilin coding sequence, and wherein the recombinant host cells secrete a recombinant resilin protein encoded by the secreted resilin coding sequence and purifying the recombinant resilin protein from the fermentation.

In some embodiments, the recombinant resilins can be cross-linked according to various methods to obtain specific recombinant resilin compositions. In various examples, cross-linking may be achieved via tyrosine residues to create di-and tri-tyrosine crosslinking in resilin to form a resilin solid. In other examples, cross linking can be achieved via lysine residues. In some examples, cross linking can be achieved via cysteine residues. In some examples, cross-linking may employ transglutaminase or poly(ethylene glycol) (PEG). In other examples, recombinant resilin can be cross-linked via enzymatic cross-linking (e.g., using horseradish peroxidase). While this method can efficiently cross-link large solutions of resilin, the resulting cross-linked product comprises covalently incorporated active enzyme in the cross-linked resilin solid. This may yield radical chain reactions that could cause degradation of the protein backbone of the resilin, if left in a resulting resilin solid. In other examples, recombinant resilin can be cross-linked via photochemical cross-linking.

Examples of additional cross-linking chemistries are disclosed in US20200022451, that may prevent degradation and make solid substances with some mechanical properties preferred for certain applications where the amount and form of energy absorption is important. In some such examples, recombinant resilin may be cross-linked via a solvent comprising ammonium persulfate (at various concentration) and application of heat (e.g., incubation at a temperature of about 80° C. for about 2.5 hours or about 3.5 hours, with other examples of heats and incubation temperatures provided therein). In some examples, other persulfates may be used. Cross-linking can also be achieved through UV activation of photocrosslinkers.

Collagen fibers can be processed by wet spinning of collagen dispersions and exhibit a characteristic fibrillar structure. Fibrils are formed during collagen self-assembly and fibrillogenesis, can be initiated by coagulation. Self-assembled collagen molecules are not covalently crosslinked and, therefore, are very weak in watery environments. To ensure suitable physicochemical properties wet spun fibers and filaments have to be chemically crosslinked after fibrillogenesis. The fibers can be cross linked with different agents, including formaldehyde, glutaraldehyde, and 1-ethyl-3-(3-dimethylaminopropyl) carbodiimid (EDC)) to increase mechanical stability. Typically, dehydrothermal treatment with glutaraldehyde exhibits the highest stability in watery environments.

The term “truncated” refers to a protein or polypeptide sequence that is shorter in length than a native protein or polypeptide. In some embodiments, the truncated protein or polypeptide can be greater than 10%, or greater than 20%, or greater than 30%, or greater than 40%, or greater than 50%, or greater than 60%, or greater than 70%, or greater than 80%, or greater than 90% of the length of the native protein or polypeptide. The minimum truncated length would be long enough to allow intermolecular cross linking and reasonably extensibility between crosslinks.

The term “resilin” as used herein refers to a protein or a polypeptide, capable of cross-linking to form an elastomer, where the protein or polypeptide is a native resilin, or a native resilin that is modified, or a native resilin that is truncated. Resilins of the present invention are preferably recombinant resilins. In some embodiments, recombinant resilins comprise a natural or modified (e.g., truncated or concatenated) nucleotide sequence coding for resilin or resilin fragments (e.g., isolated from insects), heterologously expressed and secreted from a host cell. In preferred embodiments, the secreted recombinant resilin protein is collected from a solution extracellular to the host cell.

Fibers in accordance with the disclosure can include be formed of a ratio of about 5:95 to about 50:50 crosslinked elastomeric protein: cellulose. For example, the fibers can have a ratio of about 5:95 to about 50:50 crosslinked resilin: microfibrillated cellulose. The fibers can be formed by direct spinning of a fiber forming composition in some embodiments. Fibers in accordance with the disclosure exhibit improved elasticity as compared to cellulose fibers without the elastomeric protein.

### Production of Solubilized Cellulose

Cellulose is a non-melting polymer, hence it is necessary to dissolve it in order to be able to spin it into fibers. The limited solubility of cellulose relates to the presence in the glucopyranose unit of hydroxyl groups having a dense system of intra-and intermolecular H-bonds.

Cellulose nanofibrils can be prepared by fluidizing pulp obtained from various plant sources including wood fibers. The pulp is washed according to the methods described in Nord. Pulp Pap. Res. J. (1990) 5:188. The washed pulp may be further disintegrated by passing through a high-pressure fluidizer. The nanofibrils are then coagulated in a water bath and subsequently dried into fibers.

Cellulose fibers can also be prepared in accordance with the lyocell process. This process involves use of solvents with high donor activity, such as N-methylmorpholine-N-oxide (NMMO) to solubilize the cellulose. The solubilized cellulose is then coagulated in a water bath and subsequently dried into fibers.

### Addition of Elastomeric Proteins and Crosslinking Agents to Solubilized Cellulose

One or more elastomeric proteins, including but not limited to: resilin; collagen; abductin, and octopus arterial elastomers, are incorporated into the solubilized cellulose solution prior to coagulation. In some embodiments of the invention, one or more cross-linkers, including but not limited to: chemical crosslinkers such as poly(ethylene glycol) or ammonium persulfate; or enzymatic cross-linkers such as transglutaminase or peroxidase are also added into the solubilized cellulose solution prior to coagulation. In alternative embodiments of the invention heat or UV is used to crosslink the elastomeric proteins. The solubilized cellulose material, elastomeric proteins, and optional crosslinkers, are then coagulated in a water bath to produce fibers. Heat, UV, or the optional crosslinking agents are then used to crosslink the elastomeric proteins.

### Methods for Producing a Composition Comprising Recombinant Resilin

The methods are generally performed according to conventional methods well known in the art and as described in various general and more specific references that are cited and discussed throughout the present specification unless otherwise indicated. Sambrook et al., Molecular Cloning: A Laboratory Manual, 2d ed., Cold Spring Harbor Laboratory Press, Cold Spring Harbor, N.Y., 1989; Ausubel et al., Current Protocols in Molecular Biology, Greene Publishing Associates, 1992, and Supplements to 2002); Harlow and Lane, Antibodies: A Laboratory Manual, Cold Spring Harbor Laboratory Press, Cold Spring Harbor, N.Y., 1990; Taylor and Drickamer, Introduction to Glycobiology, Oxford Univ. Press, 2003; Worthington Enzyme Manual, Worthington Biochemical Corp., Frechold, N.J.; Handbook of Biochemistry: Section A Proteins, Vol I, CRC Press, 1976; Handbook of Biochemistry: Section A Proteins, Vol II, CRC Press, 1976; Essentials of Glycobiology, Cold Spring Harbor Laboratory Press, 1999.

In some embodiments, a novel method is utilized to secrete resilin extracellularly from a host cell. In some embodiments, the method comprises constructing a vector comprising a secreted resilin coding sequence, transforming the vector into a host cell, and then culturing the recombinant host cells to secrete resilin extracellularly. In some embodiments, the secreted resilin is then purified, and the purified resilin is cross-linked to form an elastomer. In some embodiments, the methods provided herein comprise the step of transforming cells with vectors provided herein to obtain recombinant host cells provided herein. Methods for transforming cells with vectors are well-known in the art. Non-limiting examples of such methods include calcium phosphate transfection, dendrimer transfection, liposome transfection (e.g., cationic liposome transfection), cationic polymer transfection, electroporation, cell squeezing, sonoporation, optical transfection, protoplast fusion, impalefection, hyrodynamic delivery, gene gun, magnetofection, and viral transduction. One skilled in the art is able to select one or more suitable methods for transforming cells with vectors provided herein based on the knowledge in the art that certain techniques for introducing vectors work better for certain types of cells.

In some embodiments, the methods further comprise the step of culturing the recombinant host cells provided herein in culture media under conditions suitable for obtaining the fermentations provided herein. In some embodiments, the conditions and culture media are suitable to facilitate secretion of the recombinant proteins from the recombinant host cells into the culture media. Suitable culture media for use in these methods are known in the art, as are suitable culture conditions. Exemplary details of culturing yeast host cells are described in Idiris et al., Appl. Microbiol. Biotechnol. 86:403-417, 2010; Zhang et al., Biotechnol. Bioprocess. Eng. 5:275-287, 2000; Zhu, Biotechnol. Adv. 30:1158-1170, 2012; Li et al., MAbs 2:466-477, 2010.

In some embodiments the recombinant resilin protein is a full-length or truncated native resilin. In some embodiments, the native resilin is from an organism selected from the group consisting of: Drosophila sechellia, Acromyrmex echinatior, Aeshna, Haematobia irritans, Ctenocephalides felis, Bombus terrestris, Tribolium castaneum, Apis mellifera, Nasonia vitripennis, Pediculus humanus corporis, Anopheles gambiae, Glossina morsitans, Atta cephalotes, Anopheles darlingi, Acyrthosiphon pisum, Drosophila virilis, Drosophila erecta, Lutzomyia longipalpis, Rhodnius prolixus, Solenopsis invicta, Culex quinquefasciatus, Bactrocera cucurbitae, and Trichogramma pretiosum.

In some embodiments, the methods further comprise the step of purifying secreted recombinant resilins from the fermentations provided herein to obtain the recombinant resilins provided herein in FIG. 2). Purification can occur by a variety of methods known in the art for purifying secreted proteins from fermentations. Common steps in such methods include centrifugation (to remove cells) followed by precipitation of the proteins using precipitants or other suitable cosmotropes (e.g., ammonium sulfate). The precipitated protein can then be separated from the supernatant by centrifugation, and resuspended in a solvent (e.g., phosphate buffered saline [PBS]). The suspended protein can be dialyzed to remove the dissolved salts. Additionally, the dialyzed protein can be heated to denature other proteins, and the denatured proteins can be removed by centrifugation. Optionally, the purified recombinant resilins can be coacervated. In various embodiments, methods of purifying the secreted recombinant proteins from the fermentation can include various centrifugation steps in conjunction with solubilizing protein in a whole cell broth or cell pellet with known chaotropes such as urea or guanidine thiocyanate.

### Purification of Recombinant Resilin

In an example, the non-FLAG-tagged Ds_ACB and Ae_A polypeptides were chosen for purification and cross-linking. Strains RMs1221 (expressing Ds_ACB) and RMs1224 (expressing Ae_A) were grown in 500 mL of BMGY in flasks for 48 hours at 30° C. with agitation at 300 rpm. The protocol for purification was adapted from Lyons et al. (2007). Cells were pelleted by centrifugation, and supernatants were collected. Proteins were precipitated by addition of ammonium sulfate.

The precipitated proteins were resuspended in a small volume of phosphate buffered saline (PBS), and the resuspended samples were dialyzed against PBS to remove salts. The dialyzed samples were then heated to denature native proteins, and denatured proteins were removed by centrifugation. The retained supernatants contained the purified resilin polypeptides. Optionally, the retained supernatants were chilled, which caused coacervation, resulting in a concentrated lower phase and dilute upper phase. As shown in FIG. 6, Ae_A was obtained in relatively pure form whereas Ds_ACB produced 3 bands at 70 kDa, 50 kDa, and 25 kDa.

### Addition of Resilin to Cellulose Fiber/Pulp Suspension.

In one embodiment of the invention, the resilin powder used is fully soluble, not fibrillated.

The concentration of resilin ranges from 1%- 50% solid content of the mixture.

Resilin may obviate the need for any additional additives (e.g. PEO/polyethylene oxide).

### Cross-Linking of Natural or Recombinant Resilin

In some embodiments, the methods provided herein further comprise the step of cross-linking the recombinant resilins. Other embodiments identified a method to crosslink resilin, and plasticize resilin with both water and glycerol.

The resilins are typically added to the solubilized solution of cellulose nanofibrils prior to aqueous coagulation, and are then crosslinked.

For Example: A cross linker is added to the slurry so that the resilin crosslinks with itself to become elastic.

The cross link can be time based, heat activated, or UV activated.

In the case of heat or UV, those treatments will be to be applied to the fiber.

Alternative methods for cross-linking proteins are known in the art. In some embodiments, cross-linking is achieved via enzymatic cross-linking (e.g., using horseradish peroxidase). In other embodiments, cross-linking is achieved via photochemical cross-linking (see, for example, Elvin C M, Carr A G, Huson M G, Maxwell J M, Pearson R D, Vuocolo T, Liyou N E. Wong D C, Merritt D J, Dixon N E. Nature 2005, 437, 999-1002; Whittaker J L, Dutta N K. Elvin C M, Choudhury N R. Journal of Materials Chemistry B 2015, 3, 6576-79; Degtyar E, Mlynarczyk B. Fratzl P. Harrington M J. Polymer 2015, 69, 255-63). In some embodiments, cross-linking is achieved via chemical cross-linking (see, for example, Renner J N, Cherry K M, Su R S C, Liu J C. Biomacromolecules 2012, 13, 3678-85; Charanti, M B, Ifkovits, J L, Burdick, J A, Linhardt J G, Kiick, K L. Soft Matter 2009. 5, 3412-16; Li L Q, Tong Z X, Jia X Q, Kiick K L. Soft Matter 2013, 9, 665-73; Li L, Mahara A, Tong Z, Levenson E A, McGann C L, Jia X. Yamaoka T. Kiick K L. Advanced Healthcare Materials 2016, 5, 266-75).

In some embodiments, cross-linking is achieved via tyrosine residues. In other embodiments, cross linking is achieved via lysine residues. In some embodiments, cross linking is achieved via cysteine residues. In some embodiments, cross-linking employs transglutaminase (see, for example, Kim Y, Gill E, Liu J C. Enzymatic Cross-Linking of Resilin-Based Proteins for Vascular Tissue Engineering Applications. Biomacromolecules. 17(8): 2530-9).

In some embodiments, cross-linking employs poly(ethylene glycol) (PEG) (McGann C L, Levenson E A, Kiick K L. Macromol. Chem. Phys. 2013, 214, 203-13; McGann C L, Akins RE, Kiick K L. Resilin-PEG Hybrid Hydrogels Yield Degradable Elastomeric Scaffolds with Heterogeneous Microstructure. Biomacromolecules. 2016; 17(1): 128-40). In some embodiments, cross-linking occurs in vessels or molds such that the recombinant resilin compositions obtained have specific shapes or forms.

### Addition of Collagen to Solubilized Cellulose Fiber/Pulp Suspension.

It is also contemplated that solubilized collagen can be used in place of resilin to improve the elastic properties of the fibers. Spinning techniques include, but are not limited to, lyocell processes and other conventional, dissolution-based, cellulose fiber production.

### Coating of Fibers

Optionally, a coating (such as zein) can be applied to the fibers prior to spinning.

Zein is a class of prolamine protein found in maize. It is usually manufactured as a powder from corn gluten meal. Prolamines contain large amounts of the amino acids proline and glutamine (from which the name prolamine is derived) but only small amounts of arginine, lysine, and histidine. Gliadin from wheat contains 14 percent by weight of proline, 45 percent of glutamine, and very little lysine. Hordein is the prolamin from barley; zein is that from corn.

The use of prolamines is multipurpose, in some embodiments the prolamine can impart hydrophobicity and antimicrobial activity to textiles. Other embodiments the prolamines alleviate the tackiness of the fibers. The zein optimized coating conditions which rendered the highest hydrophobic character to the textiles were found to be 50 g/L zein in the free form prepared with 70% ethanol.

Optionally, the water content in the fibers can be exchanged with glycerol or other similar plasticizers through a soaking step.

The foregoing descriptions of specific embodiments of the present invention have been presented for purposes of illustration and description. They are not intended to be exhaustive or to limit the invention and method of use to the precise forms disclosed. Many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient, but is intended to cover the application or implementation without departing from the spirit or scope of the claims of the present invention.

1. A composition for use in the production of cellulose fibers, the composition comprising:
a cellulosic pulp suspension; and
one or more elastomeric proteins selected from the group comprising: resilin; collagen; abductin; and octopus arterial elastomers.

2. The composition of claim 1, wherein one of the one or more elastomeric proteins are resilin.

3. The composition of claim 1 or 2, wherein the resilin is present at a concentration of between 1%- 50% solid content of the mixture.

4. The composition of any one of claims 1 to 3, wherein the one or more elastomeric proteins are cross-linked.

5. The composition of claim 2, wherein the resilin is cross-linked or cross-linkable by heating.

6. The composition of any one of the preceding claims, further comprising a cross linking agent selected from the group comprising: poly(ethylene glycol); ammonium persulfate.

7. The composition of claim 2, wherein the resilin is cross-linked or cross-linkable by photo cross-linking.

8. The composition of claim 2, wherein the resilin is cross-linked or cross-linkable by enzymatic cross-linking.

9. The composition of any one of claims 1 to 3, further comprising transglutaminase or peroxidase for enzymatic cross-linking of the resilin.

10. The composition of claim 1, wherein one of the one or more elastomeric proteins are collagen.

11. The composition of claim 10, further comprising a crosslinking agent selected from the group consisting of formaldehyde; glutaraldehyde; and 1-ethyl-3-(3-dimethylaminopropyl) carbodiimid (EDC)

12. The composition of claim 1, further comprising one or more prolamines.

13. The composition of claim 12, wherein the one or more prolamines are selected from the group consisting of zein; gliadin; and hordein.

14. A process for the preparation of a composition for the production of cellulose fibers, the process comprising:
solubilizing cellulose obtained from plant sources by mechanical or chemical processes, to form a cellulose suspension/solution;
adding one or more elastomeric proteins to the cellulose suspension/solution, to form a cellulose-protein suspension/solution;
adding a crosslinker to the cellulose-protein suspension/solution that enables future crosslinking.

15. The process of claim 14, wherein the elastomeric proteins in the cellulose-protein suspension/solution are partially cross-linked.

16. The process of claim 15, wherein the partially cross-linked elastomeric proteins are fully cross-linked after fiber formation.

17. The process of claim 14, wherein the mechanical process comprises disintegrating the plant sources by passing through a high-pressure fluidizer.

18. The process of claim 14, wherein the chemical process comprises dissolving the cellulose in N-methylmorpholine-N-oxide.

19. The process of claim 14, wherein the one or more elastomeric proteins are selected from the group comprising: resilin; collagen; abductin, gelatin and octopus arterial elastomers.

20. The process of claim 19, wherein one of the one or more elastomeric proteins is resilin.

21. The process of claim 20, wherein the resilin is cross-linked by heating or exposure to UV.

22. The process of claim 14, wherein the composition additionally comprises one or more prolamines selected from the group comprising: zein; gliadin; and hordein.

23. A process for forming cellulose fibers, comprising:
admixing one or more elastomeric proteins with a cellulose suspension form a cellulose-protein suspension;
adding a crosslinker to the cellulose-protein suspension;
coagulating the cross-linker containing cellulose-protein suspension in a water bath to produce fibers; and
exposing the fibers to heat or irradiation to crosslink the elastomeric proteins.

24. A process for forming cellulose fibers, comprising:
admixing one or more cross-linked elastomeric proteins with a cellulose suspension form a cellulose-protein suspension;
forming fibers from the cellulose-protein suspension.

25. The process of claim 24, wherein forming fibers comprises direct spinning fibers from the cellulose-protein suspension.

26. The process of claim 24, wherein admixing one or more cross-linked elastomeric proteins with the cellulose suspension comprises admixing one or more elastomeric proteins, the cellulose suspension, and one or more cross-linkers and crosslinking the elastomeric proteins to form the cellulose-protein suspension.

27. The process of claim 24, wherein the cross-linked elastomeric proteins are cross-linked before admixing with the cellulose suspension.

28. A fiber comprising a cross-linked elastomeric protein and cellulosic fiber, wherein a ratio of the cross-linked elastomeric protein to cellulosic fiber is about 5:95 to about 50:50.

29. The fiber of claim 28. wherein the cross-linked elastomeric protein is cross-linked resilin.

30. The fiber of claim 28 or 29, wherein the cellulosic fiber is microfibrillated cellulose.
